(19) United States
(12) Patent Application Publication
(10) Pub. No.: US 2018/0093644 A1
(43) Pub. Date: Apr. 5, 2018

(54) VEHICLE CAMERA

(71) Applicant: DREAM 601 INVESTMENT CORPORATION, Taichung City (TW)

(72) Inventors: PAUL LIN, Taichung City (TW); BEN LIN, Taichung City (TW); JENG-JYH LIN, Taichung City (TW)

(21) Appl. No.: 15/718,027

(22) Filed: Sep. 28, 2017

(30) Foreign Application Priority Data
Oct. 5, 2016 (TW) 105132302

(51) Int. Cl. B60S 1/54; B60S 1/56; B08B 5/02

(52) U.S. Cl. CPC B60S 1/54; B08B 5/02; B60S 1/56

(57) ABSTRACT

A vehicle camera includes a camera and a housing. The camera has a lens unit. The housing has an accommodation space to accommodate the camera therein. The housing has an opening for the lens unit to take a photo via the opening. The housing has at least one air vent at the opening. The air vent corresponds in position to the lens unit of the camera. An inside of the housing is provided with a delivery passage for air flow to flow therethrough. One end of the delivery passage is connected to the air vent. A rear of the housing is provided with an air delivery tube and a connecting device. The air delivery tube is configured to deliver the air flow to the delivery passage. The connecting device is configured to open or close the air delivery tube. The connecting device is electrically connected with a control unit.

### FIELD OF THE INVENTION

The present invention relates to a vehicle camera, and more particularly to a vehicle camera that is provided with an air vent to eject air flow for cleaning the water droplets and dirt on the vehicle camera.

### BACKGROUND OF THE INVENTION

A vehicle camera is used as an auxiliary device when a driver backs his/her car or drives a car. Through the vehicle camera, the driver can see whether there is an obstacle between the car and other car, or through the vehicle camera to photograph the images when driving. These images can be used to protect the driver's rights or record the traffic.

However, the weather in Taiwan is humid and rainy. In rainy days, the raindrops may remain on the lens of a vehicle camera. Besides, the dust particles in the air may be mixed with water droplets. As a result, the images are blurred, which will affect the driver to determine the distance between the cars and cannot record the current road conditions. So far, the water droplets are cleaned manually. Due to the safety considerations, it is impossible to clean the water droplets when driving a car.

### SUMMARY OF THE INVENTION

The primary object of the present invention is to provide a vehicle camera. Through an air vent to eject air flow, the water droplets and dirt on the lens of the vehicle camera can be removed.

Another object of the present invention is to provide a vehicle camera, which provides a housing having an accommodation space to accommodate the camera. The shape of the accommodation space of the housing can be designed according to the actual needs. Therefore, there is no need to purchase a special-purpose camera, thereby saving the cost.

In order to achieve the aforesaid object, the vehicle camera of the present invention comprises a camera and a housing. The camera has a lens unit. The housing has an accommodation space to accommodate the camera therein. The housing has an opening for the lens unit to take a photo via the opening. The housing is provided with at least one air vent at the opening. The air vent corresponds in position to the lens unit of the camera. An inside of the housing is provided with a delivery passage for air flow to flow therethrough. One end of the delivery passage is connected to the air vent. A rear of the housing is provided with an air delivery tube and a connecting device. The air delivery tube is configured to deliver the air flow to the delivery passage. The connecting device is configured to open or close the air delivery tube. The connecting device is electrically connected with a control unit. By operating the control unit, the connecting device opens the air delivery tube to guide air flow into the delivery passage so that the air flow is blown to the lens unit through the air vent.

Through the above structure, the advantages of the present invention are described as follows:

1. When water droplets and dirt are present on the lens unit, the user can press the control unit to actuate the connecting device to deliver the air flow through the air delivery tube and the delivery passage to the air vent so that the camera has a clear view constantly.

2. The housing of the present invention has the accommodation space and the delivery passage around the periphery of the housing. Therefore, the shape of the accommodation space can be designed according to the actual needs. Therefore, there is no need to purchase a special-purpose camera, thereby saving the cost.

3. For a convenient control, the control unit is disposed on the dashboard.

4. The housing of the present invention further comprises a connecting portion on which a mounting hole is provided. The user can install the vehicle camera of the present invention on the vehicle body through a coupling bolt inserted through the mounting hole.

5. In order to enhance the cleaning effect, the housing and the camera are assembled in a recessed manner, so that the air flow ejected from the air vent can clean the water droplets and dirt on the lens unit.

### BRIEF DESCRIPTION OF THE DRAWINGS

FIG. 1 is a schematic view of the present invention installed on a vehicle;

FIG. 2 is a perspective view of the present invention;

FIG. 3 is a sectional view of the present invention;

FIG. 4 is a schematic view of the present invention when in use;

FIG. 5 is a perspective view of another embodiment of the present invention;

FIG. 6 is a sectional of FIG. 5.

### DETAILED DESCRIPTION OF THE PREFERRED EMBODIMENTS

Embodiments of the present invention will now be described, by way of example only, with reference to the accompanying drawings.

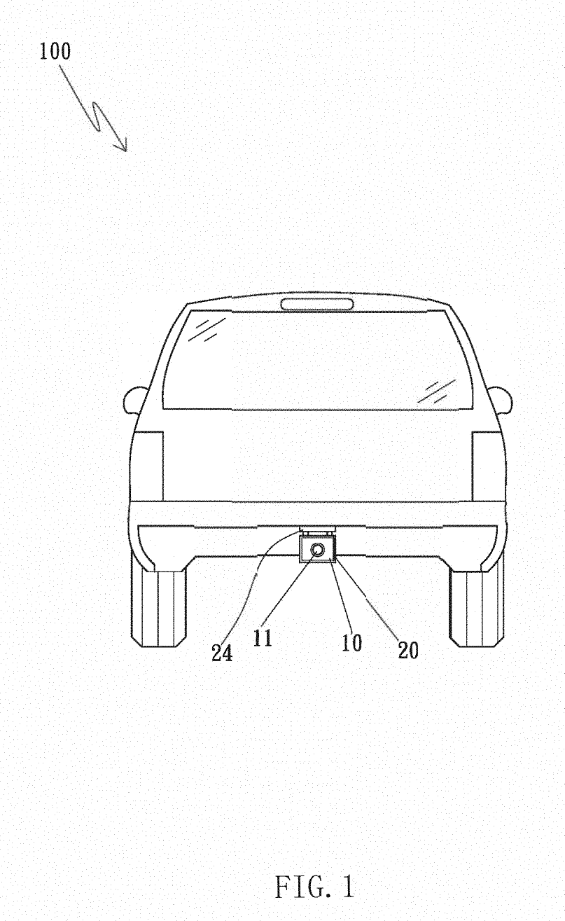

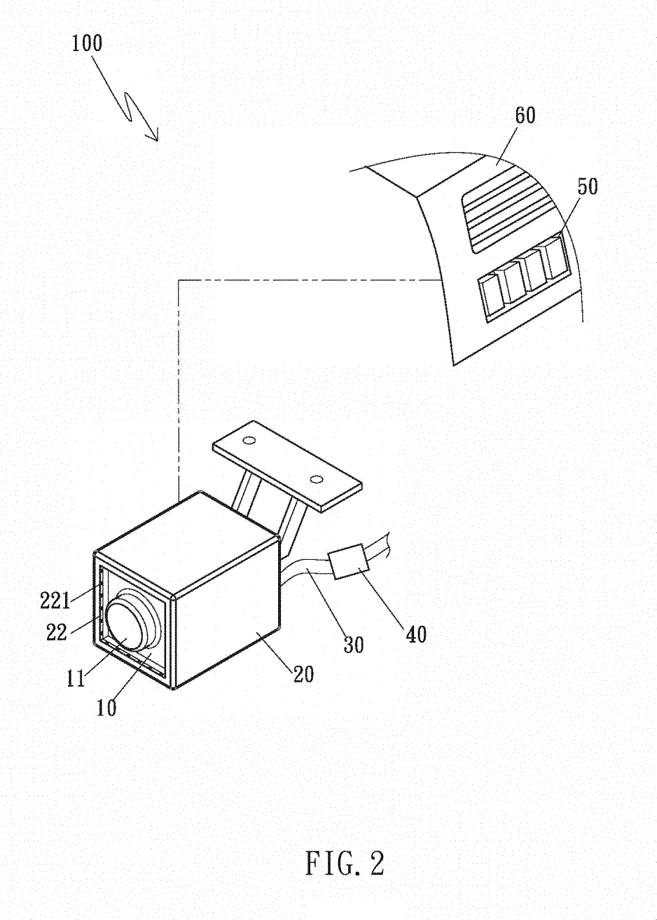

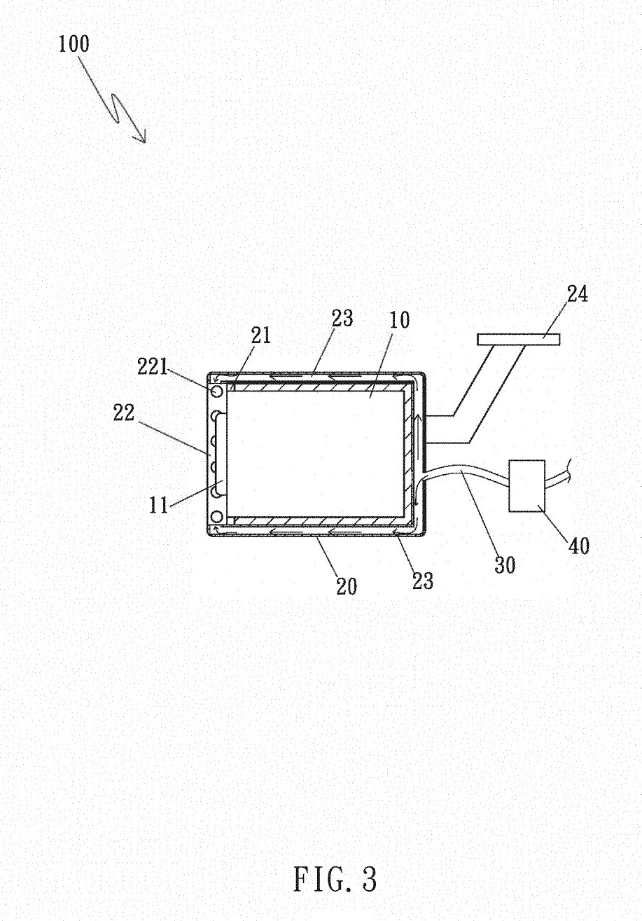

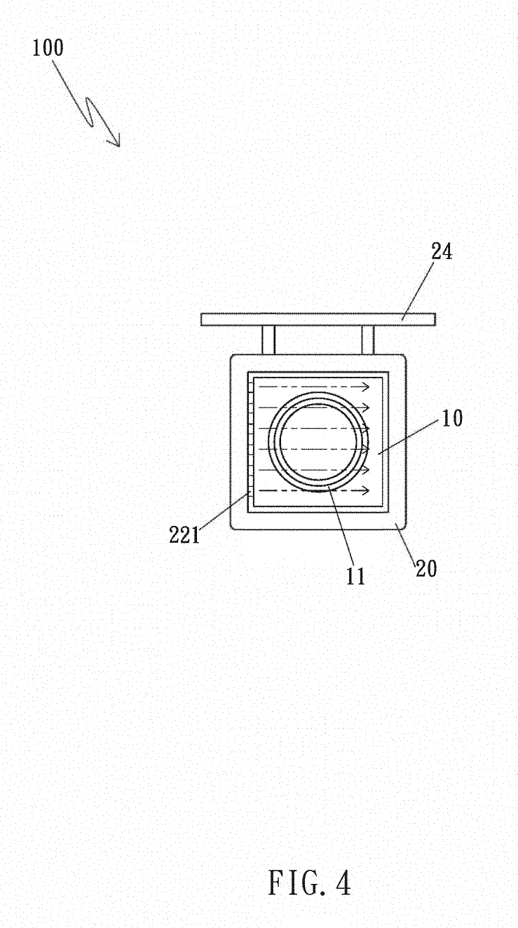

As shown in FIG. 1 to FIG. 4, the present invention discloses a vehicle camera 100. The vehicle camera 100 comprises a camera 10 and a housing 20. The camera 10 has a lens unit 11. The housing 20 has an accommodation space 21 to accommodate the camera 10 therein. The housing 20 has an opening 22 for the lens unit 11 to take a photo via the opening 22. The housing 20 is provided with at least one air vent 221 at the opening 22. The air vent 221 corresponds in position to the lens unit 11 of the camera 10. The inside of the housing 20 is provided with a delivery passage 23 for air flow to flow therethrough. One end of the delivery passage 23 is connected to the air vent 221. The rear of the housing 20 is provided with an air delivery tube 30 and a connecting device 40. The air delivery tube 30 is configured to deliver the air flow to the delivery passage 23. The connecting device 40 is configured to open or close the air delivery tube 30. The connecting device 40 is electrically connected with a control unit 50. By operating the control unit 50, the connecting device 40 opens the air delivery tube 30 to guide the air flow into the delivery passage 23 so that the air flow is blown to the lens unit 11 through the air vent 221.

Through the above structure, the use, advantages and effects of the present invention are described hereinafter.

Referring FIG. 1 to FIG. 4, first, the camera 10 is accommodated in the accommodation space 21 of the housing 20, and then the delivery tube 30 and the associated wires are assembled to the control unit 50 beside the dashboard 60, so that the connecting device 40 for controlling the opening or closing of the air flow can be used. It is to be noted that the housing 20 of the present invention further comprises a connecting portion 24 on which a mounting hole is provided. The user can install the vehicle camera of the present invention on the vehicle body through a coupling bolt inserted through the mounting hole.

Referring to FIG. 1 to FIG. 4, when water droplets and dirt are present on the lens unit 11, the user can press the control unit 50 to actuate the connecting device 40 to deliver the air flow through the air delivery tube 30 and the delivery passage 23 to the air vent 221 for blowing out the water droplets and dirt on the lens unit 11. There is no need for the user to wipe the lens, and the camera 10 has a clear view constantly.

Referring to FIG. 1 to FIG. 4, the housing 20 of the present invention has the accommodation space 21 and the delivery passage 23 around the periphery of the housing 20. Therefore, the shape of the accommodation space 21 can be designed according to the actual needs. Therefore, there is no need to purchase a special-purpose camera 10, thereby saving the cost.

As to the source of the air flow of the present invention, one side of a vehicle cooling fan is provided with an air storage tank. The air storage tank is provided with a multi-directional valve. One end of the multi-directional valve is used for storing air, and another end of the multi-directional valve is connected with the air delivery tube 30. Through the control unit 50, the connecting device 40 is actuated to deliver the air flow to the air vent 221 for cleaning the lens unit 11. In addition, in order to have an easy control, the connecting device 40 uses a solenoid valve to improve the practicability of the present invention by its accurate and easy-to-install characteristics.

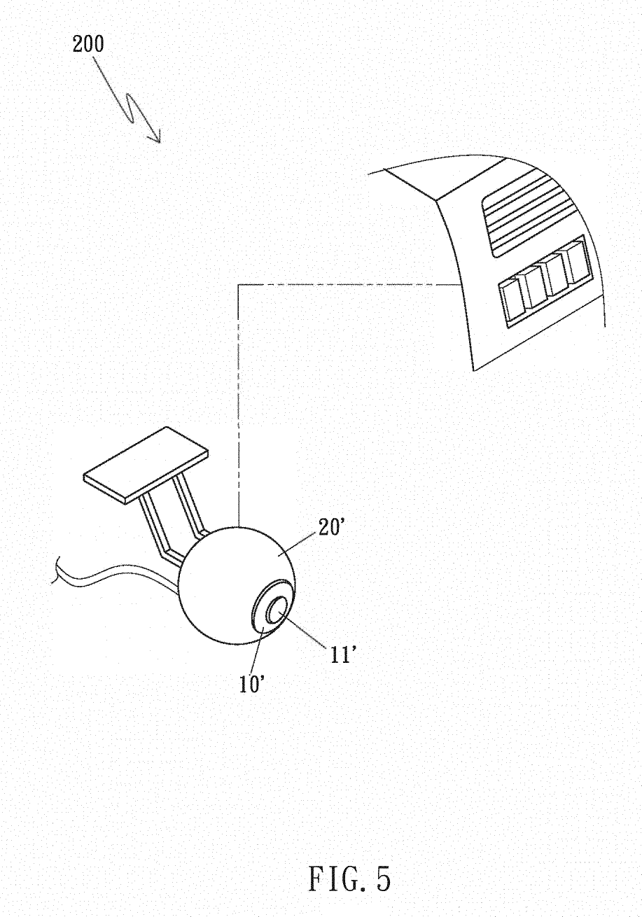

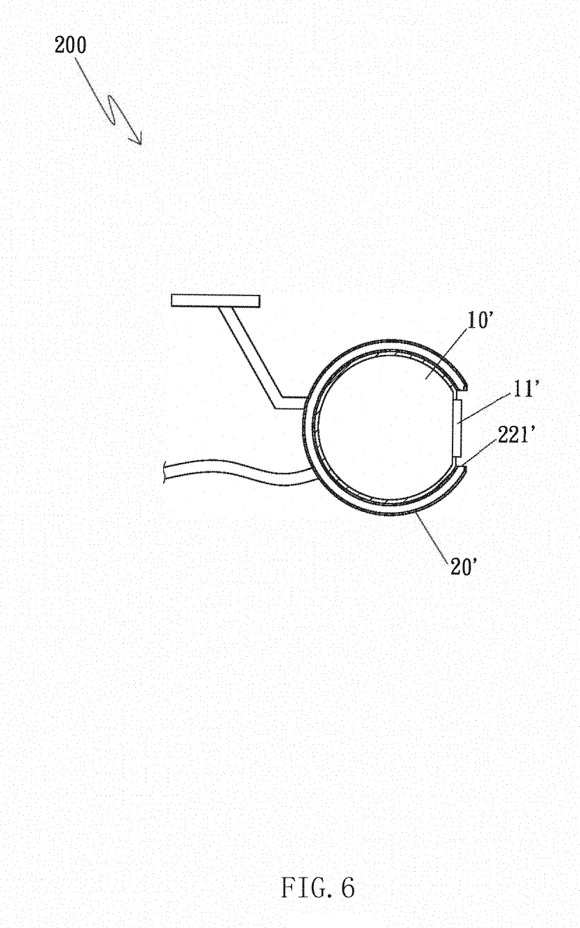

FIG. 5 and FIG. 6 illustrate the vehicle camera 200 according to another embodiment of the present invention, which is substantially similar to the aforesaid embodiment with the exceptions described hereinafter. The camera 10′ has a sphere shape. The lens unit 11′ of the sphere camera 10′ has a retractable design. The housing 20′ and the camera 10′ are assembled in a recessed manner, so that the air flow ejected from the air vent 221′ can clean the water droplets and dirt on the lens unit 11′.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A vehicle camera, comprising a camera and a housing, the camera having a lens unit, the housing having an accommodation space to accommodate the camera therein, the housing having an opening for the lens unit to take a photo via the opening, characterized by: the housing being provided with at least one air vent at the opening, the air vent corresponding in position to the lens unit of the camera, an inside of the housing being provided with a delivery passage for air flow to flow therethrough, one end of the delivery passage being connected to the air vent, a rear of the housing being provided with an air delivery tube and a connecting device, the air delivery tube being configured to deliver the air flow to the delivery passage, the connecting device being configured to open or close the air delivery tube, the connecting device being electrically connected with a control unit, by operating the control unit, the connecting device opening the air delivery tube to guide the air flow into the delivery passage so that the air flow is blown to the lens unit through the air vent; the housing including a connecting portion; and
the housing and the camera being assembled in a recessed manner.

2. The vehicle camera as claimed in claim 1, wherein the connecting device is a solenoid valve.

3. The vehicle camera as claimed in claim 1, wherein the control unit is disposed on a dashboard.
